(19) United States
(12) Patent Application Publication
(10) Pub. No.: US 2008/0086504 A1
(43) Pub. Date: Apr. 10, 2008

(54) VIRTUAL INTERVIEW SYSTEM

(76) Inventors: Joseph Sanders, Rosewell, GA (US); Timothy Rochon, Rochester Hills, MI (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/539,001

(22) Filed: Oct. 5, 2006

(51) Int. Cl. G06F 17/00

(52) U.S. Cl. 707/104.1

(57) ABSTRACT

A virtual interview system that includes: a web accessible interface for interviewers and candidates, a database, and one or more workstations for accessing job postings and conducting interviews. The web accessible interface allows interview candidates to provide profile information and resume information. In addition, the web accessible interface allows interviewers or recruiters to list job descriptions, postings, etc., and to retrieve and review virtual interviews. A candidate creates a virtual interview by visiting a workstation, searching for a job posting and then initiating a virtual interview. The candidate is presented with questions in a format selected by the candidate. The candidate's responses are recorded and stored as a virtual interview. The interviewers may access the information regarding a client in multi-staged fashion to prevent the presentation of EEOC related data at the early stages of the interview review process. In addition, the interviewer may provide comments related to the candidate for other interviewers to review.

### BACKGROUND OF THE INVENTION

There you sit, having left your home in plenty of time to reach your destination, yet you find yourself plopping down into a leather chair in the lobby of your destination just minutes before your appointment. Having endured unbelievable traffic, you can barely calm your nerves, knowing just how close you could have come to missing your appointment. On top of this you just remember that you left your updated resume and references in the trunk of your car and in a hurry to get out the door this morning, you put on one black shoe and one brown shoe. You are totally flustered and can't even think straight. Meanwhile, somewhere down the hallway sits another person, slumped over their desk, overwhelmed by the piles of work sitting on the desk and threatening to ruin the upcoming weekend. This person who is too busy to even take a coffee break, just moments ago received a call from the receptionist that the 9:00 AM interview, which was totally forgotten by this person, has just arrived. This person frantically looks over your resume and mentally reviews a list of soon to be asked questions. What are the odds that the upcoming job interview is going to adequately determine whether you are the right person for the job? Identifying quality candidates through an interview process is a difficult task even under the best of circumstances but, when coupled with the above-presented quite possible scenario, this task is exceedingly difficult.

The traditional interviewing approach in most companies is to solicit resumes through one or more potential means, including help-wanted ads, recruiting companies, etc. The hopefully piles of resumes may then be reviewed, categorized, and filtered by a human resource employee before being passed to department heads. The department heads then review the stack of filtered and categorized resumes, maybe passing them to some of his or her employees for review, and then selecting a list of prospects. These are passed back to the human resource department to have interviews arranged. The human resource department contacts the necessary employees to set up an interview schedule and contacts each of the prospects to arrange the interview time, date, and if necessary, travel and accommodations. The scheduled interviews then take place leaving the employees that conducted the interview with a few notes scribbled on a resume or note pad, and a memory of the interview. Clearly, the amount of time, effort and expenses that are expended in such a process are not proportionate to the received product. In addition, there is little consistency to be gleamed for such an interview process. For instance, if one employee/candidate pair hit if off (i.e., they went to the same school and may have many common interests), the questions asked may be entirely different than if the employee does not hit it off with the candidate. Which scenario provides the best interview results? It is difficult to determine. Using traditional interviewing techniques, a company must base hiring decisions only based on the notes and impressions of the individuals conducting the interview. It would be greatly beneficial for a company to have the ability to review the entire interview, maybe even with side by side comparisons of the potential candidates, have the exact content that was presented during the interview, provide interview consistency across the candidate pool, eliminate the element of personalities in the interviewing process, and reduce the amount of time and effort required by the employees. Thus, there is a need in the art for a technique to improve the interviewing process with these requirements in mind.

### BRIEF SUMMARY OF THE INVENTION

The present invention addresses these and other needs in the art by providing a virtual interview program (VIP) that consists of a web accessible interface, a database and one or more workstations. In general, the VIP presents interview to potential candidates and records the responses, in audio, video or both formats, and stores them in the database for future access by the interviewers. The web accessible interface enables interviewers and recruiters to post job listings and job descriptions. In addition, potential interview candidates provide their profile information and resumes through the web interface. The web accessible interface is also used to allow interviewers to review candidate information and virtual interviews.

More specifically, candidates access the web interface to create an account and input profile and resume information. Subsequent to registering, the candidate is instructed to visit a workstation to engage in an interview. When the candidate logs into the workstation, the candidate is presented with several options regarding the maintenance of his or her account, as well as the ability to search for job postings. When a job posting is displayed to the candidate, the candidate may initiate a virtual interview. The workstations typically include a video camera and microphone for recording the candidates responses to questions. One aspect of the present invention is to allow the candidate to customize the presentation of the questions. For instance, the candidate may select the workstation to mirror back the candidate's interview, display a blank screen, display a static picture, or the like.

Viewers can access the database to review virtual interviews that have been previously recorded. In one embodiment, the virtual interview is presented in a phased manner to address EEOC concerns. In this embodiment, only partial information is initially presented and if the viewer wants to look at addition information, he or she may request the same. Advantageously, this aspect of the invention allows information that can give rise to EEOC concerns to be filtered at the early stages and then only presented as the viewer becomes more interested in the candidate based on other information.

Another aspect of the present invention is to enable viewers to provide comments regarding the candidate, the virtual interview or other information. In one embodiment, these comments can be access restricted. For instance, the comments may be accessible only by the employer and recruiter, of the comments may be accessible to the candidate, or the comments may be accessible to all. Various levels of access restriction and access categorizations can be applied regarding the comments.

Another aspect of the present invention is to provide alerts to the interviewers regarding the availability of virtual interviews. For instance, an interviewer may be notified each time an interview is completed for a particular position. In contrast, the interviewer may set up the system to only be notified upon the reception of a threshold number of interviews.

These and other aspects of the present invention will be more clearly understood upon reviewing the detailed description and figures.

### BRIEF DESCRIPTION OF THE DRAWINGS

FIG. 1 is a conceptual system diagram for an exemplary environment suitable for embodiments of the present invention.

FIG. 2A is a screen shot of an exemplary registration interface.

FIG. 2B is a screen shot of an exemplary information confirmation page that may be displayed by an embodiment of the present invention.

FIG. 3 is a screen shot of an exemplary Industry/Category selection screen that may be displayed by an embodiment of the present invention.

FIGS. 4A and 4B are exemplary screen shots of resume input screens presented to a user of an embodiment of the present invention.

FIG. 5 is a screen shot showing the confirmation page indicating that a user has successfully provided the necessary information to enroll in the VIP system.

FIG. 6 is a flow chart showing the steps involved in one exemplary embodiment of the EEOC checkpoint aspect of the present invention.

FIG. 7 is an exemplary screen shot illustrating a candidate screen providing viewer comments to the candidate.

### DETAILED DESCRIPTION OF THE INVENTION

The present invention provides a network based interviewing solution to the above-described needs in the art, as well as other needs. In general, the present invention, sometimes referred to within this description as the Virtual Interview Program, provides an interactive way to use the internet, or other global network, for conducting various types of interviews, such as but not limited to employment interviews. More specifically, one embodiment of the Virtual Interview Program operates on a customized station or other properly equipped computer work station that is capable of rendering audio and/or video to the participant and capturing and recording audio and video content. A participant, such as an employee candidate, using the work station will be presented with a series of questions or requests that can be presented either as text on a display, audio, and/or audio/video content. The participant responds to each question or request by verbally replying and possibly also typing data into the work station if necessary. The questions or requests presented to the participant, as well as the participants responses, are joined together or otherwise associated with each other and made available to the interested party, such as by posting them to a website on the internet. In such an embodiment, anyone authorized to view responses can access the website, select a specific question and then view the specific response with audio and video.

The present invention will generally be described from the perspective of the overall platform or environment in which the invention can be embodied. Following the overall description of the Virtual Interview Program (referred to as the VIP for short), specific aspects and/or features of the present invention are described.

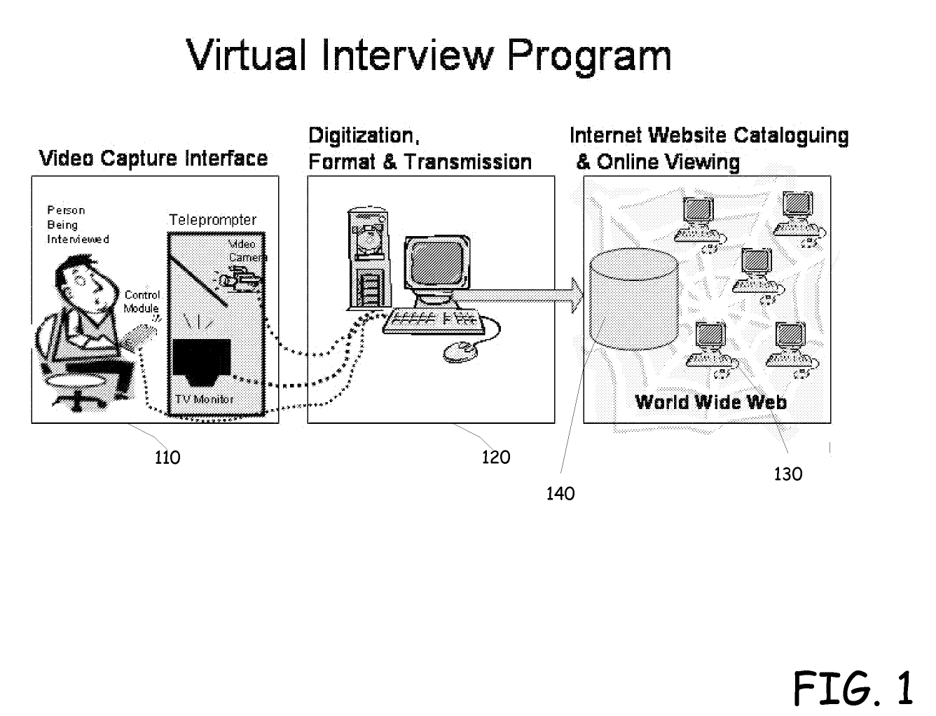

FIG. 1 is a conceptual system diagram for an exemplary environment suitable for embodiments of the present invention. The exemplary VIP system is shown as including four main components: (1) the local user interface 110; (2) a conversion and transmission system 120; (3) a web session application review/management interface 130, and (4) a web accessible database 140. These components can be connected or communicate with each other using a variety of techniques. For instance, they may share data over in IP network, or may be directly connected, connected over a proprietary network, or otherwise or even a combination of multiple ways. For purposes of illustration, a particular embodiment of the VIP is presented. The described VIP is a web-based product that may include a local client based interface to ensure high quality video; however, other embodiments of the present invention, including stand-alone kiosks or other embodiments are also anticipated. Prior to use of the VIP, individuals must register. Registration may be performed at one of the VIP stations, or in other embodiments, may be performed by accessing a website, mailing in an application, having the information entered over the telephone or other technique. Once a user is registered, or as part of the registration process, the user then selects a category and inputs a profile. The profile typically includes information that would be normally found on a resume. At this point, the user may access a VIP station and initiate and complete an interview session.

The interviews on the VIP station can fall into at least two categories: (a) general interviews and (b) company specific interviews. For the general interviews, a list of questions can be presented to the participants and the interviews recorded and stored into a database. Upon request, the available interviews in the database can be searched for applicable interviews and then presented to the requester, such as a company. Alternatively, a company may be given searching access to the database. Such an embodiment would be most applicable for companies the provide services like MONSTER.COM. Company specific interviews are when a particular company is interviewing candidates for a particular position or multiple positions. The questions presented in company specific interviews are selected by or on behalf of the company and are geared towards identifying a qualified candidate for the particular position. For company or otherwise specific interviews, the user may receive an authorization code during the registration process. For instance, a recruiter or company may provide candidates with the access code to participate in an interview. The authorization code will give the user access to either a specific interview or a list of categories/jobs being offered by a particular company or by a particular recruiter.

In some embodiments, the registration process may require the user to provide an authorization code. For instance, a candidate that is referred by a company receives a company authorization code. The authorization code may give the user access to a specific job posting and an interview associated with that job opening or, it may simply give the user access to a general interview for the company. A user wishing to register on the system first must enter the authorization code and once accepted, can continue with the standard registration. In addition, the authorization code may trigger the provision of special instructions that are provided to the candidate.

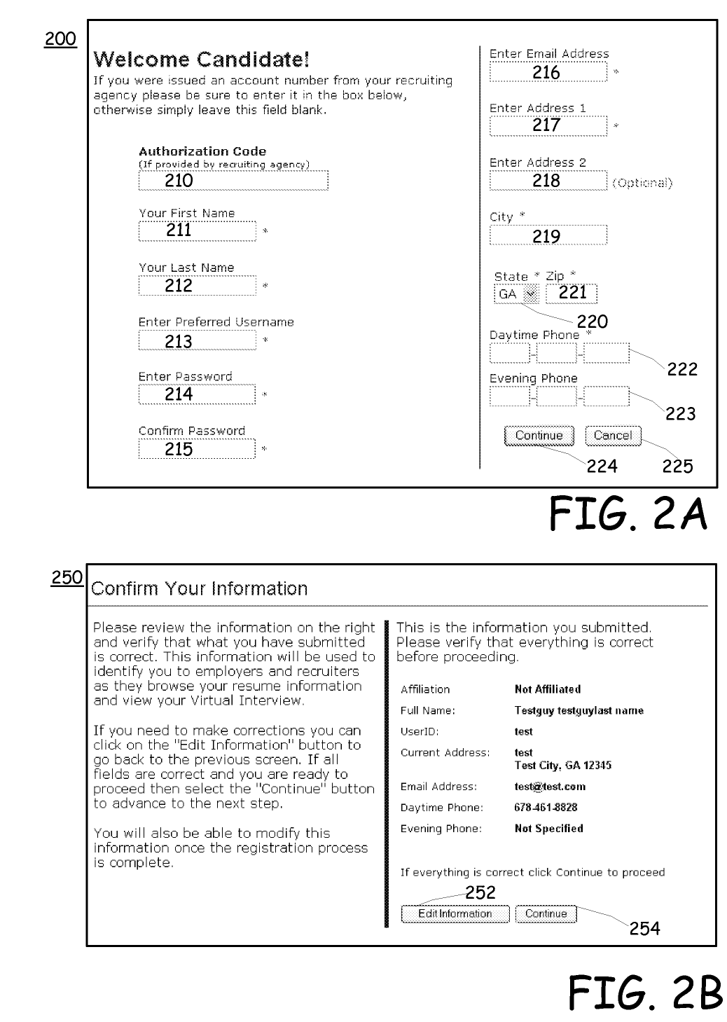

FIG. 2A is a screen shot of an exemplary registration interface. As a specific and non-limiting example, a user may access a VIP website and receive the rendering of the registration interface shown in FIG. 2A. Using registration information interface screen 200, the user then enters the following information: Authorization Code 210, First Name 211, Last Name 212, Preferred User Name 213, Password 214, Confirm Password 215, Email Address 216, Address line 1 217, Address line 2 218, City 219, State 220, Zip 221, Day-time Phone Number 222 and Night-time Phone number 223. It will be appreciated that other information may also be required or some of the listed information may be omitted in various embodiments of the present invention. Once the user enters the information, the user can select to continue 224 or to cancel the registration process 225.

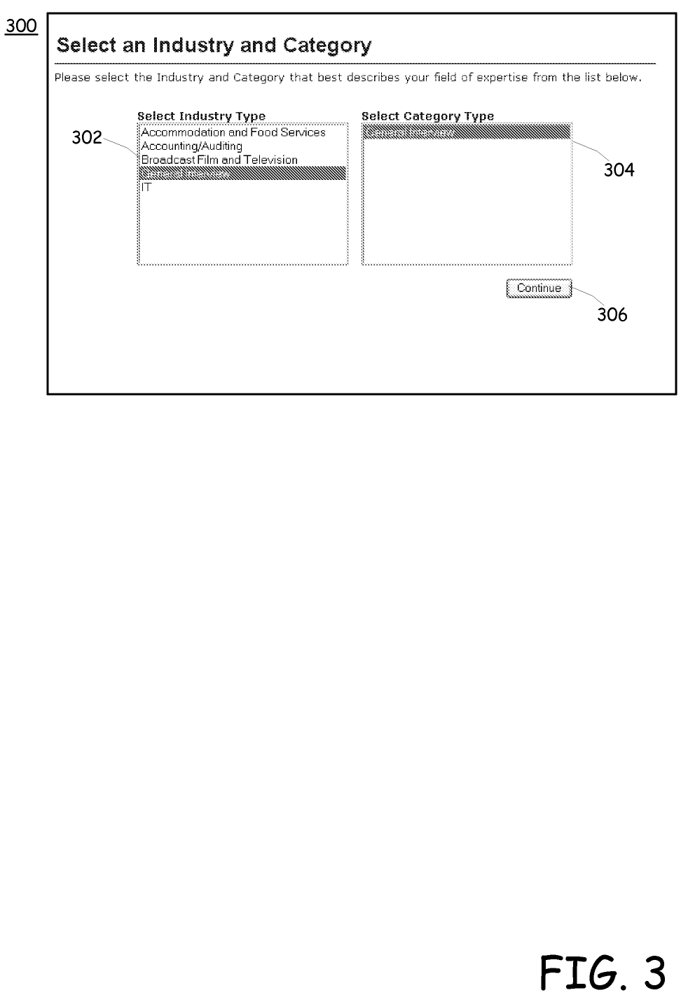

If the user selects to continue by activating the continue button 224, the user is presented with an information confirmation screen 250 and requested to review and confirm that the information is correct. FIG. 2B is a screen shot of an exemplary information confirmation page that may be displayed by an embodiment of the present invention. The company information affiliated with the authorization code, if any is typically displayed on the information confirmation page. The company can allow a general interview authorization which would pull general human resource questions to allow greater flexibility in the interview process. If there are any errors in the entered data or if changes need to be made, the user can activate the edit information button 252 to return to the registration information interface screen 200. Otherwise, the user can activate the continue button 254 to cause the information to be submitted to a database. If an authorization code was entered and the authorization code is affiliated with a recruiter, then a recruiter selector screen is presented. Otherwise or subsequent to this, the user is presented with an Industry/Category selection screen 300. FIG. 3 is a screen shot of an exemplary Industry/Category selection screen that may be displayed by an embodiment of the present invention. The recruiter selector screen allows the user to select a specific recruiter and job interviews available through that recruiter, whether it be company based or field of experience based.

The Industry/Category selection screen 300 provides the user with the opportunity to narrow down the field of potential interviews to relevant interviews based on the user's experience. The user can select an industry 302 and a category 304 and then activate the continue key 306. The system then passes the entered information from the registration information interface screen 200 and the industry/category screen 300 are passed to a database for storage.

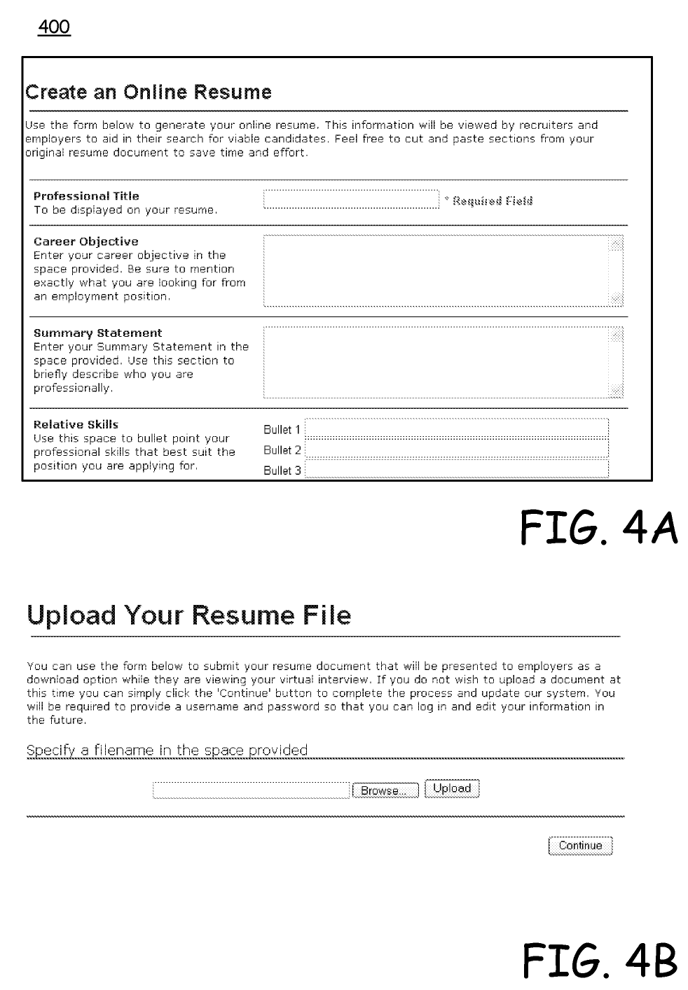

FIGS. 4A and 4B are exemplary screen shots of resume input screens presented to a user of an embodiment of the present invention. Once the user has entered the registration information, the recruiter information and the industry/category information as necessary, the user is presented with a resume input screen 400. In an exemplary embodiment, a resume capture function of the VIP includes three resume input form screens. Further, a timer is used to require the user to complete the inputting of information within a specific period of time, such as 120 minutes per page in one embodiment. FIG. 4A only illustrates one of the potential pages for a user to enter resume information. It will be appreciated that a wide variety of embodiments may require differing levels of information and the illustrated embodiment is provided as a non-limiting example. Once the resume information is input by a user, the user can choose to save and/or upload the resume information through an interface screen similar to the one shown in FIG. 4B.

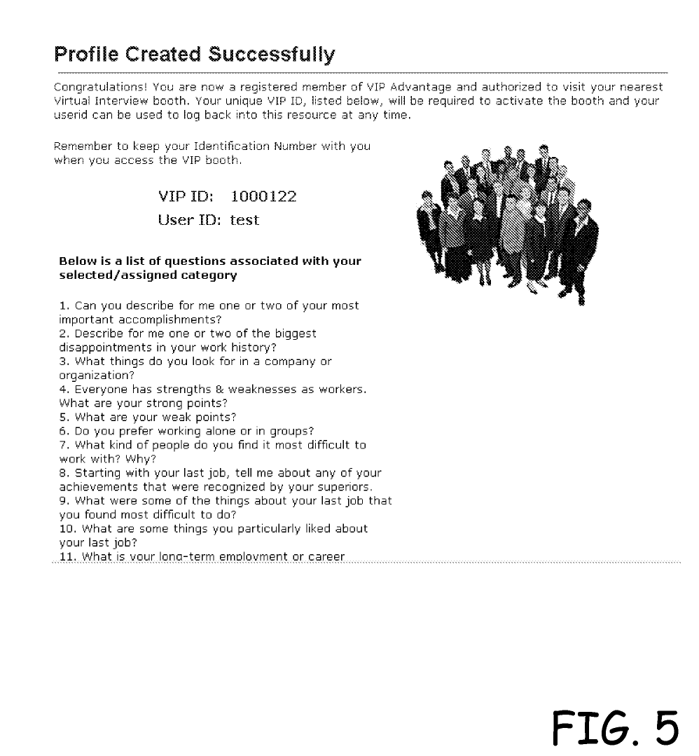

FIG. 5 is a screen shot showing the confirmation page indicating that a user has successfully provided the necessary information to enroll in the VIP system. The user is provided with a VIP ID and User ID and is presented with questions pertaining to the specific industry selected by the candidate or the authorization code. The user is also instructed to visit the nearest VIP office, kiosk or work station to complete a virtual interview.

In some embodiments, the user may register without the use of an authorization code. In this embodiment, a payment module may be inserted into the registration process to require the user to enter payment collection information to pay a registration fee. Once the user enters the payment information, the user activates a continuation button to take the user to a registration information page. The registration page for a user without an authorization code can be identical to the screen illustrated in FIG. 2A without requiring the user to enter the authorization code 210 or, the screen may completely eliminate the authorization code 210 entry field. The different screen presentation can be based on the user having just entered payment information.

The VIP allows recruiters to post interviews, accept interviews and provide them to various companies. In an exemplary embodiment, the recruiter can access the VIP system by visiting the VIP website and logging into the system. Once logged into the VIP system, the recruiter is presented with a registration page. Similar to the registration page illustrated in FIG. 2A, the recruiter enters information into the system. In an exemplary embodiment, the information entered by recruiters includes the following information: Recruiter's First Name, Recruiter's Last Name, Recruiter's Company Name, Address, City, State, Zip Code, Telephone, Second Telephone, Mobile Telephone, email address and Recruiter's ID if applicable. Once the recruiter enters the information, the recruiter activates the continue button to have the information submitted to the VIP system. The VIP system verifies that all necessary information has been entered in a proper format and if so, the information is stored into the database. Otherwise, the recruiter is instructed on what measures to take to correct the data. Once the data has been accepted, a Create and ID page is presented to the recruiter to allow them to create a new user name and select a password. If the user name and password are determined to be unique by the VIP system, they are accepted and a validation screen showing the new VIP user name and password is displayed to the recruiter for confirmation.

The VIP allows employers to access the system after completing a registration process. In an exemplary embodiment, the employer access the VIP system by visiting the VIP website and logging into the system as an employer. Once logged into the VIP system as an employer, the employer is presented with a registration page. Similar to the registration page illustrated in FIG. 2A, the employer enters information into the system. In an exemplary embodiment, the information entered by the employer includes the following information: First Name, Last Name, Company Name, Address, City, State, Zip Code, Telephone, Second Telephone, Mobile Telephone, and email address. The employer registration page may also include a checkbox asking the employer “Do you need/Would you like to find a recruiting firm in your area?” and requests the employer to check the box accordingly. The employer may then activate the continue button to have the information verified by the VIP system and then submitted to the database for storage. In an exemplary embodiment, a pull-down screen of recruiters can be presented to the employer to select a recruiter. Once the recruiter is selected, an email or message can be sent to an identified contact person for the recruiting company. The VIP system then creates an account ID and presents a Create ID page to the employer. The employer then enters a new user name and password. Once this information is entered, the VIP system verifies that the entered user name and password combination is unique and if so, then present a validation screen to the employer. The validation screen identifies the new VIP user name and password. In addition, the employer may be presented with an option to print out the user name and password or have them emailed to the employer's email address. The VIP system then thanks the employer for registering and instructs the employer to use the VIP user name and password for future log-ins.

When the VIP system is up and running, individuals (or candidates) can access the VIP system either through a VIP workstation, kiosk, website, etc. The candidate gains access to the VIP system by entering his or her self created username and password, and possibly a VIP number also. If the VIP determines that a valid username/password combination is entered, the VIP presents a verification/welcome page to the candidate. The candidate is then or also presented with options to choose from. In an exemplary embodiment, the options presented to the candidate may include the following:

(1) Email VIP session

(2) Edit profile information

(3) Change password

(4) View virtual interview

(5) Update online resume

(6) Upload resume

(7) Change or add recruiter

(8) Job search engine (ability for candidate to search for jobs)

(9) Cancel or reschedule pending interviews

(10) Participate in interview

By selecting the first option, the candidate can forward a recorded interview system to a recruiter, candidate, human resource representative, another party for review and criticism, etc. By selecting option (2), the candidate can edit/revise his or her profile information or by selecting option (3), change the password for accessing the VIP system. Selecting option (4) allows a candidate to view a virtual interview prior to sending it to a prospective employer. The candidate can update his or her resume by selecting option (5) and upload a new or revised resume by selecting option (6). The candidate can change or add a recruiter by selecting option (7). The candidate may search for available jobs, job descriptions, and available options by selecting option (8). By selecting option (8), the candidate may respond to a job by participating in a VIP session and then sending the recorded session to the prospective employer.

In other embodiments, other features or options may also be available. For instance, the candidate may be able to review a history of the number of times his or her recorded interview has been viewed by potential employers. In addition, the candidate may be presented the option to create a cover letter and to mail multiple cover letters and multiple online resumes to various parties. In some embodiments, the candidates may be allowed to upload multiple resumes. In some embodiments, the candidate may be able to create a new VIP session, thus enabling multiple sessions to exist on one VIP number or login. In another embodiment, the option (1) described above can be further enhanced to allow a candidate to select one or more of multiple VIP sessions to be emailed to one or more destinations. Another feature that can be made available in various embodiments includes a multi-level access setting for the candidate profiles, resumes, VIP sessions, etc. Using this feature, the candidate can make such items private, semi-private or public.

If the candidate selects option (10) an interview with the candidate can commence. The interview may also be initiated by conducting a search for job listings, companies, recruiters or authorization codes, and then selecting the desired job listing, company, recruiter or otherwise activating the desired interview. The candidate is presented with one question at a time and given the opportunity to respond. The question may be presented in a variety of manners. A few non-limiting examples include textually displaying the questions, audibly playing the questions, having a video clip of a person asking the question. The candidate responds by answering the question audibly, which is then recorded and stored in the system. The candidate may also be requested to type information into they system using a keyboard. Thus, the candidate can be presented with multiple choice questions and requested to provide a selection, or the candidate can be requested to enter data necessary by the company, such as contact information of references. In another embodiment, the kiosk or workstation can be used to test the skill sets of the candidate. For instance, a typing test can be presented to the candidate by displaying text on a screen and requesting the candidate to take a five minute speed typing test.

As the candidate answers questions, the response can be stored as a single file containing the entire interview and/or the questions can be stored individually allowing individual access to each question across a candidate pool. For responses stored individually, they can be stored in a relational database providing searchable access to employers, interviewers and recruiters based on various fields such as, candidate name, date of interview, job position, company, industry/category, etc. The responses may also be given a unique identification number such as appending the candidate identification number, recruiter identification number, question identification number, category identification, etc. Various other schemes can also be applied.

The VIP system enables an employer to set up interviews and post job openings for others to view through providing an employer portal. In an exemplary embodiment, a designated person from a company, such as someone in the human resources department, or anyone wishing to interview candidates (such as looking for a baby sitter or house keeper), simply access the web site or the workstation and selects the “companies seeking employees” option. In general, the user is presented with a screen allowing the user to enter contact information, billing preferences (i.e. by invoice, credit card, etc.), create an id and password, or the like. Once the user is completed with this process, the user submits the information to the VIP system. The system then issues and authorization identifier number to the user. At this point, the user is an official interviewer from the perspective of the VIP system. Every company, entity or person that registers as an interviewer receives an authorization identification number or code. Once the user is registered and identified as an interviewer, they are returned to a main screen for further actions or the interview can log out to return at a different time.

When the interviewer is passed to the main screen, either after registration or by logging back into the system, the interview is presented with several options and information, including the following options and information that are presented as a non-limiting example:

A window or a portion of the screen being dedicated to the display of:

The interviewers contact information along with an edit button that can be selected to modify the contact information

A listing of all jobs that have been posted by the interviewer (possibly in a scrollable window if the number of interviews exceeds a threshold amount)

A listing of all jobs posted with a candidate application attached

A list of favorites containing follow-up candidates

A search option for all candidates so that they can identify applicable job postings or interviews

An option to post a new job listing or modify/delete a previously entered job listing

If the interviewer selects to post a job listing, the interviewer is presented with a form to input data relating to new job, submit the data for approval and then receive a job number based on the authorization code plus the number of the job posting

If the interviewer wants to modify an existing job listing, the interviewer can search for the job listing by specific job number or a word/category search, identify the job listing and then select the edit feature, after which the interviewer is presented with an editable and filled out form for modification

An option to create or modify a job or position record

Maintain questions for jobs posted by that particular interviewer

Review interviews associated with a job posting

One of the options that an employer can select in an embodiment of the present invention is to have an email sent to the interviewer when ever an interview has been completed by a candidate. When the interviewer receives the email, the interviewer can open the email and click on a link embedded in the email message. The link may include logon information and candidate interview information and by clicking on the link, the interviewer is taken directly to a page containing the virtual interview. At this point, the interview is ready to be presented to the interviewer.

While listening or upon completion of the interview, the interviewer can select one of several options. For instance, in one embodiment, the interviewer can reject the candidate, request further information on the candidate, notify the candidate that the interviewer wants to follow up by taking the next step, browse for more candidates, etc. More specifically, one option for the interviewer is to indicated that they are very interested in the candidate and request the candidate or the candidates recruiter to give the interviewer a call. Upon selecting this option, an email may be sent to the recruiter providing all the pertinent information. Another option is that the employer may reject the candidate and possibly request the recruiter to send another candidate to the employer. Again, this can be performed through an email message. Another option is that the employer may browse the site for more recommended candidates. For instance, once the company has been sent the link that includes the company identifier, the registered interviewers have access to an area in which they can browse, review and select candidates that fit particular criteria or that have been assigned by the recruiter.

Yet another option is that the registered interviewer may enter a candidate identification number and obtain a recruiter or candidate status. In one embodiment, this option would return a notice saying the candidate is no longer active or available or, would return information regarding the recruiter. Another option is that the registered interviewer may be able to email a job listing to potential targets. This feature allows a potential candidate to receive an email, click on an embedded line and then be taken to a registration page with the association code having been pre-populated. This aspect of the invention results in the candidate being able to pull up or access specific position questions.

The VIP system also provides a recruiter portal to enable a recruiter to enter candidates, solicit candidates, manage candidates, and present candidates to a prospective employer or position. Once the recruiter is registered, the recruiter is either led to the main recruiter page or when the recruiter logs back in and enters the newly self created username and password he is led to this page. The options presented to the recruiter in an exemplary embodiment of the present invention may include one of more of the following options:

(a) edit profile information,

(b) view the virtual interview of an assigned candidates,

(c) show candidate assignments (will show all of the candidates assigned to the recruiter)

(d) select and send a virtual interview to a company, the system will pre-populate all of the necessary information in a preformatted email so that the company may just click on the link and the interview will start

(e) search for candidates based on key fields and that are unassigned or assigned to that recruiting agency

(f) add, edit and view jobs posted by the recruiter

(g) access reporting features such as generating a report indicating the number of candidates assigned to the recruiter, the number of candidates assigned by industry with an active link to access the candidates or generate a list based on this or other criteria

(f) send a status change request to a candidate, which once received the candidate can click on one or more links to confirm or modify the status change and enter the status change.

Another aspect of the VIP system is that job searches can be performed. A member of the public may enter the site and select the option to search for a job. If a person finds a job that interests them, they can activate the “apply for job” option. Once this is activated, the person is sent to the VIP registration with the authorization code for that job pre-populated in the registration screen. They then proceed to fill out all pertinent personal information and are given the question set. The question set page will instruct them the person to proceed to a VIP equipped workstation. However, if the person is already a registered user, after clicking the “apply for job” option, they will be directed to a login page and, upon logging in they will be presented with the questions for the job and instructed to visit a VIP station.

An embodiment of the present invention can allow and administrative function which enables an administrator to log in to the system and perform administrative actions. Some of these administrative actions may include, but are not limited to:

(1) delete any job in the system

(2) delete any candidate in the system

(3) delete any company in the system

(4) add new industry and job, for a company or in general

(5) retrieve an authorization code

As illustrated in FIG. 1, an embodiment of the present VIP system includes a database system 140. The overall functionality of the database system is to (a) store information about the registrar, (b) store and maintain information about the interviewer, (c) store questions for use in interviews and provide access techniques for the questions, (d) store information relating a candidate and a selected position, (e) store job posting information, and (f) provide access to job postings by interviewer.

One aspect of an embodiment of the present invention is providing question sets to candidates, or as interview building templates to interviewers, based on a hierarchical structure. For instance, in one embodiment, a question set is generated and provided to a candidate based on the position selected by the candidate or the company identified by the candidate. In an exemplary embodiment, the hierarchy of questions starts by associating questions with the interview type which breaks the question down on a general category. Thus, the “general” questions are the standard industry questions. Further, questions can be associated with a company which would then pull in the standard questions that relate more closely to the particular company. As an example of a hierarchy, the questions can be associated and selectable based on the following structure:

interviewer type;

industry type;

category; and

position being applied for.

One exemplary method to provide the categorization of available questions is to allow each question to have relational matrix associated with it. The matrix can include all or many of the potential categorizations, such as interview type, industries, categories, positions, companies, etc. and have a true indicator in each position of the matrix to which the question belongs. Thus, in such an embodiment, the questions can be shared or included across multiple categories (i.e., the questions are not mutually exclusive to a category).

Various capabilities can be built into the database system 140 to facilitate the building of question sets and the access to the question sets. For instance, an interviewer may have the option, when posting a job listing, when registering, or otherwise, to associate an industry/category and questions related thereto with a new company. In addition, the system may allow an interviewer or recruiter to add new industry/category entries and to add/revise/delete questions. The database may also store previously created authorization codes and provide the interview or recruiter with access to them. The database may also provide privacy and/or access control to the various profiles within the system by allowing them to be identified as private, semi-private and public folders.

Another technique that can be employed by various embodiments of the present invention is to categorize the questions based on the point of access. For instance, if a kiosk is being used for taking job interviews, the kiosk (or work station) can be associated with a particular company or it may be identified as a general access booth. If the kiosk is associated with a particular company, then when candidates access it, they are only presented with job positing for that particular company and only presented with questions that have been identified with that particular company. The association of the kiosk with the company can be accomplished in a variety of manners, such as including an kiosk table stored in memory, which includes one or more attributes to be used to associate the kiosk in various manners (i.e., with a particular company, for a particular job posting, for a particular industry, etc.).

Thus, a general description of an exemplary embodiment of the present invention has been described. Although the present invention is not limited to the above-described embodiment, certain aspects and features of the above-described embodiment may in and of themselves be considered novel.

An additional aspect of the present invention is to provide equal employment opportunity (EEO) checkpoints by providing tiering. In general, this aspect of the present invention addresses EEOC concerns that give rise in the hiring process by enabling the review of an interview in a staged manner. The staging can be coordinated to ensure that the employer minimizes the risk of an EEOC violation. This aspect of the present invention provides the reviewer with graduated access to various portions of the interview. For instance, in one embodiment of the invention, the reviewer is first presented with only the resume of the candidate. The present invention may also operate to filter EEOC triggers from the application. For instance, while a candidate is inputting a resume, or after the resume has been entered, the text can be scanned for words and phrases that may indicate racial, gender, age and other EEOC related topics, and then filter this information from the resume. Once the resume has been reviewed and accepted, the reviewer can be presented with the candidates responses to the questions or a certain question in a textual format. Once the questions have been reviewed and accepted, the reviewer may be presented with the audio content of the interview or the answer to a question. If the audio is accepted, then the video content of the interview can be presented to the reviewer. During this entire process, the acceptance/rejection codes or selections made by the reviewer are recorded into the system to show when and where the rejection takes place. This data can be archived and then reported on a regular basis.

More specifically, one embodiment of the EEO aspect of the present invention allows a user to review a session in phases organized into checkpoints. The VIP system will provide checkpoints as determined by company criteria. The company may enable certain fields to be shown on the application or redacted from the application depending on government and company policies.

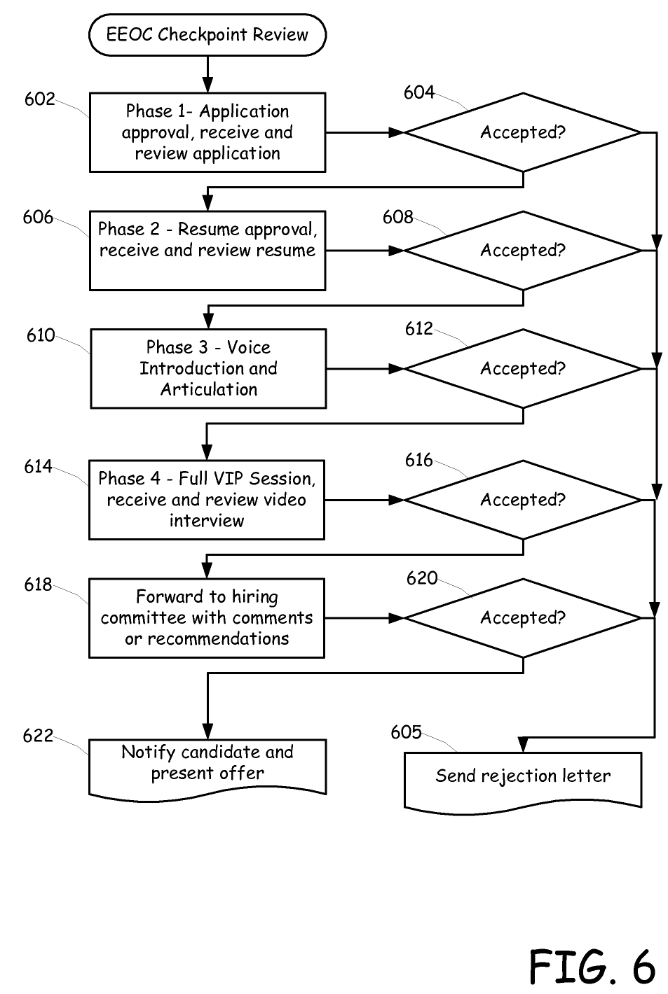

FIG. 6 is a flow chart showing the steps involved in one exemplary embodiment of the EEOC checkpoint aspect of the present invention. Initially, the application is presented to the reviewer from the VIP database, or it may be imported from the clients system via web services or a customized interface 602. This first presentation of the application is referred to as Phase I—Application Acknowledgement & Acceptance.

If the application is accepted 604 in terms of meeting the company's qualifications, the reviewer may proceed to the next phase by acknowledging and accepting the qualifications of the candidate. By accepting the application, the reviewer will then proceed to the next checkpoint of the session referred to as Phase II—Resume Approval 606. However, if the application is rejected, the candidate is notified in one of several manners, such as sending a rejection letter 605.

During Phase II 606, the reviewer is presented with a VIP Online Resume or the manual resume uploaded by the applicant to the VIP system. The VIP Online Resume also has the ability to mask certain fields of information if warranted by company or government policy. After reviewing the resume, the reviewer acknowledges and accepts or acknowledges and declines the resume based on company criteria 608. If the resume is accepted, the reviewer proceeds to the next checkpoint referred to as Phase III—Voice Confirmation & Articulation 610. If the resume is declined 608, a customized decline letter may be sent to the applicant 605.

In Phase III 610, the reviewer is presented with the audio content of the interview, either in its entirety or question by question. If the reviewer is satisfied with articulation and introduction they will acknowledge and accept the candidate 612 and then move to the next phase referred to as Phase IV—Video session 614. However, if the candidate is rejected 612, then this again may trigger the mailing of a decline letter 605.

During Phase IV 614, the reviewer is presented with the entire video interview enabling the reviewer to see facial expressions, professional appearance, etc. Once Phase IV is accepted or rejected 616 the screening process is typically complete. The session may be sent with a recommendation to the hiring manager 618. However, it will be appreciated that in some embodiments, the hiring manager or committee may still reject the candidate 620, in which case the candidate is sent a decline letter 605. Otherwise, if the candidate is accepted, processing continues at step 622 where the candidate is offered a position.

It will be appreciated that several employees may review the interview prior to making a decision. This EEOC process may be active for each such viewing or, the checkpoint option can be enabled for the firsts viewing and then disabled for the next reviewer of the same content based on company policy and preference. Thus, this aspect of the present invention allows portions of the review process that may give rise to EEOC issues to be pushed to the end of the review process. This enables reviewers to accept or reject a candidate early in the process on a non-EEOC related basis without the concern of having EEOC charges levied against the employer.

Another aspect of the present invention is the ability to post and forward comments regarding or pertaining to a VIP interview. In general, when a candidate interview is being reviewed by an employer, recruiter or interviewer (collectively the viewer), the viewer can record comments related to the candidate or the viewers impressions or thoughts, save the comments and then have the option to forward the VIP interview of the candidate with or without the recorded comments to another viewer.

More specifically, the post and forward comments aspect of the present invention allows a viewers comments to be attached or associated with a candidate profile. The comments that are provided can be viewed by others with the appropriate authorization code, if any. In such an embodiment, the authorization code is a unique ID associated with an organization or company. Each organization or company may have multiple authorization codes to grant varying levels of access or access restrictions for the comments. The comments may be added to a candidates profile in a variety of manners. For instance, in one embodiment a “forward comment” button within the comments field for a candidate can be selected or activated. Once entered, when ever a profile or interview is forwarded via email or other means, eligible recipients of the email will be presented with a “review comments” button within the email. For instance, when an employer creates interviewer profiles, those that are eligible to see comments may be identified in their profile as a forwarded email invitation user. Other interviewers can be restricted or prevented from accessing the comments. Thus, emails received by these interviewers will not include the “review comments” button. When the “review comments” button is activated, the comments are presented to the interviewer in either text, audio, video or a combination thereof forms. Likewise, the employer/recruiter can set the privilege levels of the interviewers and as such, only authorized users may comment on a candidate.

The comments that are provided by the various interviewers can be cataloged by a date and time stamp with the user ID or username automatically included along with the comment. In addition, the comments may be identified by access levels either automatically based on the identity of the person providing the comment, or manually by the interviewer selecting an access level. For instance, if the interviewer is in the human resources department, the system may be set up so that only those in the human resource department and company officers may review the comments. Similarly, the comments may be set to be reviewed by only people in a specific department or department heads, etc. If the person receiving an interview to review is not on the VIP system, but rather is invited to review the interview through the email message, then the email address will serve as the user name and thus, if comments are left, the comments will be associated with the user name.

In some embodiments, the interview can be forwarded to an outside source for review. The outside source then clicks on a link to access the interview. In this embodiment, the comments regarding the interview are not available unless specifically authorized. As mentioned earlier, the authorization can be provided while creating the comment (i.e., by selecting the “view general comments on forward” option) or may be automatically provided based on the person leaving the comment.

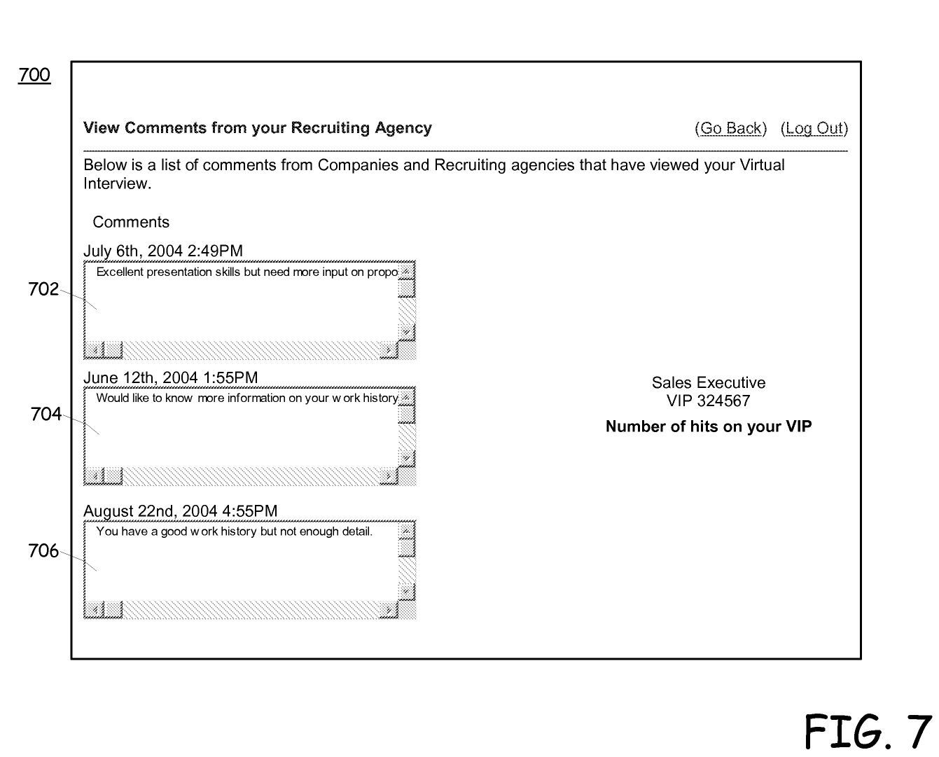

An embodiment of the present invention may also be used to provide feedback comments to the candidate. FIG. 7 is an exemplary screen shot illustrating a candidate screen providing viewer comments to the candidate. The comments can be provided by a recruiter or an employer while viewing an interview or other aspects depending on what phase is active when the comment is created. The candidate, upon logging into the system can view comments left regarding his or her interview or profile. The candidate may then use this feedback to revise the resume, profile or interview or simply respond a question posed by the interviewer. As a non-limiting example, the employer may leave a comment such as “are you available to work on weekends”, “are you available to work shift work”, or “are you able to travel 80% of the time”. The candidate can review these comments and then provide comments back to the poser, either through another feature in the VIP system of via another channel such as email or telephone.

Another feature of this aspect of the present invention is that the interviewer can further protect or prevent access to the comments by providing password access to the comments. For example, if the viewer wants to make comments for his or her personal reference, the viewer may want to make the comments password protected. Similar, this feature of the invention can be used to limit access to a group of viewers, those provided with the password information. The reviewing user may also make their comments private by password protecting their comments for added security (these comments would serve as notes to themselves). Another embodiment for this aspect of the invention is, rather than employing password protection, to make the comments private except to a user logged in under the same account. Thus, only those with access to the user identification and password will have the ability to view the comments.

Another aspect of the present invention is to tag or categorize interviews that have been viewed. For instance, one embodiment of this aspect allows the viewer to flag a VIP session as a favorite and place them in a separate holding group. This holding group can then be separately searchable or accessed by selecting a favorites button. Similarly, other categorizations can be used in various embodiments of the present invention. As a non-limiting example, the categorizations may include one or more of the following:

(a) under qualified

(b) check back with this candidate in X months

(c) this is a good candidate for XYZ department

(d) bring this candidate in for a personal interview

(e) rank this candidate as a Level X candidate

Another aspect of the present invention is to provide company alerts or candidate ready alerts. This aspect of the present invention operates to send notifications to particular parties upon the occurrence of certain events. For instance, in one embodiment of the invention, when an interview is submitted, the recruiter or other identified recipient is notified. In another embodiment of the invention, a recipient may identify a threshold number of interviews that must be received before being notified. Using this aspect of the present invention, an interviewer can force the system to only notify him or her when X number of interviews have been received. This aspect of the present invention can be implemented in a variety of manners. For instance, each interviewer, when entering his or her profiles, may identify the notification characteristics desired. As a non-limiting example, the lower level employees that will be reviewing interviews may be set up to only be notified after the department heads have reviewed and not rejected the candidates. In addition, the employees outside of human resources may be setup to only be notified after the human resources department has reviewed and conducted background checks on the candidates.

One embodiment of the present invention provides a selectable/customizable VIP session interface screen. This aspect of the present invention allows a candidate to configure the type of interface that will be presented to the candidate during the virtual interview. For instance, one embodiment of this aspect of the present invention may present the following options to the candidate to choose from:

(a) static photo of company logo or picture

(b) live video of candidate (mirror option)

(c) still shot of interviewer or company employee

(d) recorded video of interviewer asking question

(e) recorded video of interviewer asking question then reverting to one of the other options listed above.

(f) blank screen

(g) textual display of the question

This option can be enabled when the candidate registers by selecting the available options or, at the time that the interview is conducted. In addition, buttons may be provided to allow the candidate to switch views during the interview process. In other embodiments, the interviewer, recruiter or company may be enabled to select the format in which the interview questions are presented. In yet another format, the interviewer may provide a list of formats that are selectable by the candidate.

Thus, it has been shown that the present invention provides a system and a technique for providing virtual interviews. The present invention has been described using detailed descriptions of embodiments thereof that are provided by way of example and are not intended to limit the scope of the invention. The described embodiments comprise different aspects and features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

What is claimed is:

1. A method for conducting virtual interviews for the review and selection of candidate, the method comprising the steps of:
accepting one or more position registrations from an entity;
accepting a candidate registration;
accepting a login request from the candidate;
presenting one or more of the one or more positions to the candidate;
presenting a set of questions related to a selected one of the one or more presented positions;
receiving responses to the questions from the candidate;
recording the responses as a virtual interview; and
making the virtual interview available for viewing by the entity.

2. The method of claim 1, further comprising the steps of:
receiving a comment from the viewing entity regarding a portion of a virtual interview; and
storing the comment in a manner that is accessible by subsequent viewers of the virtual interview.

3. The method of claim 2, further comprising the step of selecting an access restriction level for the comment.

4. The method of claim 1, wherein the step of accepting a candidate registration further comprises the steps of:
receiving a profile input for the candidate;
receiving an application for the candidate; and
receiving a resume for the candidate.

5. The method of claim 4, wherein the step of making the virtual interview available for viewing comprises the steps of:
presenting the candidate application to the viewing entity.

6. The method of claim 5, wherein in response to the viewing entity accepting the application, presenting the resume to the viewing entity.

7. The method of claim 6, wherein in response to the viewing entity accepting the resume, presenting the audio portion of the virtual interview to the viewing entity.

8. The method of claim 7, wherein in response to the viewing entity accepting the audio portion of the virtual interview, presenting the video and audio portion of the virtual interview to the viewing entity.

9. The method of claim 8, wherein in response to the viewing entity accepting the video and audio portion of the virtual interview, forwarding the virtual interview to a hiring entity with recommendations to hire the candidate.

10. The method of claim 1, wherein after the step of accepting a login request from the candidate, presenting the questions to the candidate in a format selected by the candidate.

11. The method of claim 10, wherein the format is selected by the candidate during the candidate registration process.

12. The method of claim 10, wherein the format is selected by the candidate after logging in process.

13. The method of claim 10, wherein the format is selected by the candidate subsequent to the logging in process.

14. A virtual interview system comprising:
a web accessible interface system for interviewers and candidates;
a database for storing:
profile information entered by the candidates;
virtual interviews of the candidates; and
questions to be posed to a candidate;
a workstation including a video camera, audio microphone and a display for:
receiving a login from a candidate;
receiving a selection of an interview;
rendering a set of questions associated with the selected interview on the display;
recording the video and audio responses of the candidate to the rendered questions; and
creating a virtual interview based on the recorded responses.

15. The virtual interview system of claim 14, wherein the profile information includes an application and a resume.

16. The virtual interview system of claim 14, wherein the web accessible interface enables an interviewer to:
review a virtual interview;
input comments pertaining to the candidate; and
make the comments accessible to other interviewers.

17. The virtual interview system of claim 16, wherein the web accessible interface enables the comments to be accessible to other interviewers subject to access restrictions.

18. The virtual interview system of claim 14, wherein the workstation is operable to render the set of questions associated with the selected interview on the display in a format selectable by the candidate.

19. The virtual interview system of claim 14, wherein the virtual interview system is operable to send a notification to an interviewer upon detecting a threshold number of virtual interviews being received.

20. A method for conducting virtual interviews for the review and selection of candidate, the method comprising the steps of:
accepting a plurality of position registrations from an entity;
accepting a plurality of candidate registration;
accepting a login request from a particular candidate;
presenting one or more of the plurality of positions to the candidate based at least in part on the candidate registration;
receiving a presentation format selection from the candidate;
presenting a set of questions related to a selected one of the one or more presented positions in accordance with the presentation format selection;
receiving responses to the questions from the candidate;
recording the responses as a virtual interview; and
making the virtual interview available for viewing by the entity.
